(19) United States
(12) Patent Application Publication
(10) Pub. No.: US 2025/0117023 A1
(43) Pub. Date: Apr. 10, 2025

(54) AUTONOMOUS MOVEMENT SYSTEM

(71) Applicant: MAKITA CORPORATION, Anjo-shi (JP)

(72) Inventors: Tatsuya YOSHIKAWA, Anjo-shi (JP); Hirokatsu YAMAMOTO, Anjo-shi (JP); Masahiro KOJIMA, Anjo-shi (JP); Genki TOYODA, Anjo-shi (JP)

(73) Assignee: MAKITA CORPORATION, Anjo-shi (JP)

(21) Appl. No.: 18/901,958

(22) Filed: Sep. 30, 2024

(30) Foreign Application Priority Data
Oct. 10, 2023 (JP) 2023-175541

(51) Int. Cl. G05D 1/661; B60L 53/36; H02J 7/00

(52) U.S. Cl. CPC G05D 1/661; H02J 7/0042; H02J 7/0068; B60L 53/36

(57) ABSTRACT

The working robot may include: a movement unit configured to move the working robot; a movement motor configured to drive the movement unit; a battery; a control unit configured to control the movement motor; and a robot power receiver. The charging station may include: a station power transmitter; and a station plate placed on a ground. When the working robot is docked with the charging station and in an unchargeable state in which charging to the battery is unable to be started, the control unit may execute a docking retry process to move the working robot by the movement unit and dock the working robot again with the charging station. While the working robot is moving during the docking retry process, at least a part of the working robot may overlap the station plate as viewed in a direction perpendicular to the ground.

### REFERENCE TO RELATED APPLICATION

This application claims priority to Japanese Patent Application No. 2023-175541, filed on Oct. 10, 2023, the entire contents of which are hereby incorporated by reference into the present application.

### TECHNICAL FIELD

The disclosure herewith relates to an autonomous movement system.

### BACKGROUND ART

US Patent Application Publication No. 2013/0006418 describes an autonomous movement system. The autonomous movement system includes a working robot configured to perform an operation while autonomously moving in a working area and a charging station configured to allow the working robot to dock thereto and charge the working robot. The working robot includes a working unit configured to perform the operation, a movement unit configured to move the working robot, a movement motor configured to drive the movement unit, a battery configured to be charged at the charging station and supply power to the movement motor, a control unit configured to control the movement motor, and a robot power receiver configured to receive power for charging the battery from the charging station while the working robot is docked with the charging station. The charging station includes a station power transmitter configured to supply the power for charging the battery to the robot power receiver and a station plate placed on the ground. When the working robot is docked with the charging station and in an unchargeable state in which charging to the battery is unable to be started, the control unit executes a docking retry process to move the working robot by the movement unit and dock the working robot again with the charging station.

### SUMMARY

In autonomous movement systems such as the one described above, it is desirable that the docking retry process is executed efficiently. The disclosure herein provides a technology that enables a docking retry process to be executed efficiently.

An autonomous movement system disclosed herein may comprise: a working robot configured to perform an operation while moving autonomously in a working area; and a charging station configured to charge the working robot and allow the working robot to dock therewith. The working robot may comprise: a working unit configured to perform the operation; a movement unit configured to move the working robot; a movement motor configured to drive the movement unit; a battery configured to be charged at the charging station and supply power to the movement motor; a control unit configured to control the movement motor; and a robot power receiver configured to receive power for charging the battery from the charging station while the working robot is docked with the charging station. The charging station may comprise: a station power transmitter configured to supply the power for charging the battery to the robot power receiver; and a station plate placed on a ground. When the working robot is docked with the charging station and in an unchargeable state in which charging to the battery is unable to be started, the control unit may execute a docking retry process to move the working robot by the movement unit and dock the working robot again with the charging station. While the working robot is moving during the docking retry process, at least a part of the working robot may overlap the station plate as viewed in a direction perpendicular to the ground.

According to the configuration above, while the working robot is moving during the docking retry process, at least a part of the working robot remains overlapping the station plate. Thus, the distance for which the working robot moves is shorter as compared to a distance for which the working robot would move when it completely moves away from the station plate. Therefore, the docking retry process can be executed efficiently.

### BRIEF DESCRIPTION OF DRAWINGS

FIG. 1 schematically shows an autonomous movement system 10 according to a first embodiment.

FIG. 2 shows a side view of a working robot 12 and a charging station 14, according to the first embodiment.

FIG. 3 shows a front view of the working robot 12, according to the first embodiment.

FIG. 4 shows a rear view of the working robot 12, according to the first embodiment.

FIG. 5 shows a top view of the working robot 12, according to the first embodiment.

FIG. 6 shows an electrical block diagram of the working robot 12, according to the first embodiment.

FIG. 7 schematically shows a part of the autonomous movement system 10 near the charging station 14, according to the first embodiment.

FIG. 8 shows an enlarged perspective view of a docking member 98 of the charging station 14, according to the first embodiment.

FIG. 9 shows a cross-sectional view of the working robot 12 and the charging station 14, where the working robot 12 is docked with the charging station 14 in the autonomous movement system 10 according to the first embodiment.

FIG. 10 shows current waveforms CW1 of a first electric signal and current waveforms CW2 of a second electric signal, according to the first embodiment.

FIG. 11 shows a waveform indicating magnetic field intensities within and out of a working area WA, according to the first embodiment.

FIG. 12 shows a waveform indicating magnetic field intensities within and out of an area surrounded by a station wire 20, according to the first embodiment.

FIG. 13 shows a flowchart of an autonomous control process, according to the first embodiment.

FIG. 14 shows a flowchart of a docking process, according to the first embodiment.

FIG. 15 shows a top view of the working robot 12 and the charging station 14 after a retreating process of a docking retry process, according to the first embodiment.

FIG. 16 shows a top view of the working robot 12 and the charging station 14 after an advancing process of the docking retry process, according to the first embodiment.

FIG. 17 shows a flowchart of a docking process, according to a second embodiment.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved autonomous movement systems, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, the robot power receiver may be a robot charging terminal configured to be electrically connected to the charging station when the working robot is docked with the charging station. The station power transmitter may be a station charging terminal configured to be electrically connected to the robot charging terminal. The docking retry process may comprise a separation process to separate the working robot from the charging station. The robot charging terminal may be separated away from the station charging terminal after the separation process.

The robot charging terminal may fail to electrically connect to the station charging terminal due to interposition of a foreign matter between the robot charging terminal and the station charging terminal. Since the robot charging terminal is separated from the station charging terminal in the configuration above, such a foreign matter falls off from the interface between the robot charging terminal and the station charging terminal. Thus, the robot charging terminal can be electrically connected to the station charging terminal.

In one or more embodiments, the control unit may be configured to drive the movement motor at a predetermined number of rotations in the docking retry process.

Control by the control unit may be made complicated if the number of rotations of the movement motor is varied every time the docking retry process is executed. The configuration above suppresses the complexity in control by the control unit.

In one or more embodiments, during the docking retry process, a part of the working robot that corresponds to 50% or more of a length of the working robot in a robot longitudinal direction may overlap the station plate as the working robot is viewed in the direction perpendicular to the ground.

The configuration above allows for a reduction in a moving distance of the working robot during the docking retry process.

In one or more embodiments, as viewed in the direction perpendicular to the ground, the working robot may have a first area. During the docking retry process, a part of the working robot that corresponds to 50% or more of the first area of the working robot may overlap the station plate as the working robot is viewed in the direction perpendicular to the ground.

The configuration above allows for a reduction in a moving distance of the working robot during the docking retry process.

In one or more embodiments, the docking retry process may comprise: a retreating process to move the working robot rearward; and an advancing process to move the working robot forward after the retreating process.

The configuration above facilitates docking the working robot to the charging station as compared to a configuration in which the working robot turns to dock with the charging station.

In one or more embodiments, a retreating distance by which the working robot moves rearward in the retreating process may be equal to or more than 50 mm and equal to or less than 650 mm.

The configuration above allows the working robot to undock from the charging station while suppressing the working robot from moving away from the station plate.

In one or more embodiments, the retreating distance may be equal to or more than 150 mm and equal to or less than 300 mm.

The configuration above allows the working robot to undock from the charging station while suppressing the working robot from moving away from the station plate.

In one or more embodiments, the autonomous movement system may further comprise an informing unit configured to inform a user. The control unit may be configured to execute the docking retry process once or more; and control the informing unit when a number of the docking retry process executed reaches a reference number.

When the number of docking retry processes executed reaches the reference number, an abnormality, such as an abnormality between the robot power receiver and the station power transmitter, often occurs. The configuration above can inform the user of such an abnormality through the informing unit.

In one or more embodiments, the control unit may be configured to stop the movement motor when the number of the docking retry process executed reaches the reference number.

The configuration above allows the working robot to be stopped until the user approaches the working robot.

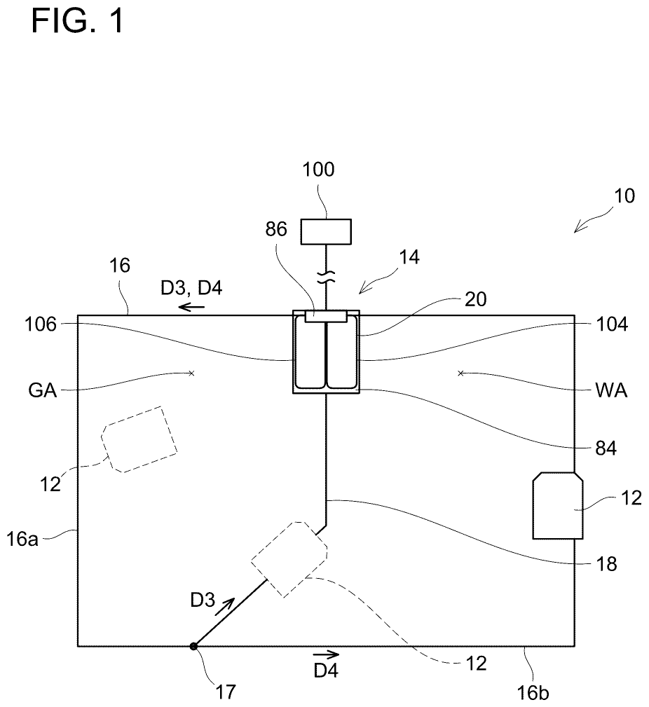

(First Embodiment) As shown in FIG. 1, an autonomous movement system 10 comprises a working robot 12, a charging station 14, a boundary wire 16, a guide wire 18, and a station wire 20. The working robot 12 is for example a mower. The working robot 12 is placed on the ground for use. The working robot 12 mows a lawn on the ground while autonomously moving within a working area WA enclosed by the boundary wire 16. Hereinafter, the longitudinal direction of the working robot 12 is termed a front-rear direction, the width direction of the working robot 12 is termed a right-left direction, and the direction perpendicular to the front-rear direction and the right-left direction is termed an up-down direction. The up-down direction is perpendicular to the ground.

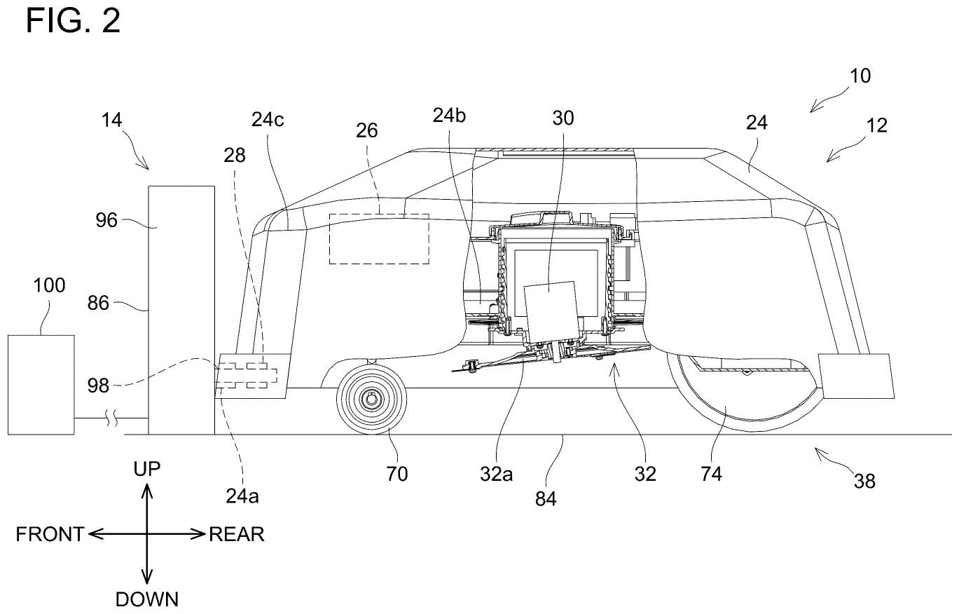

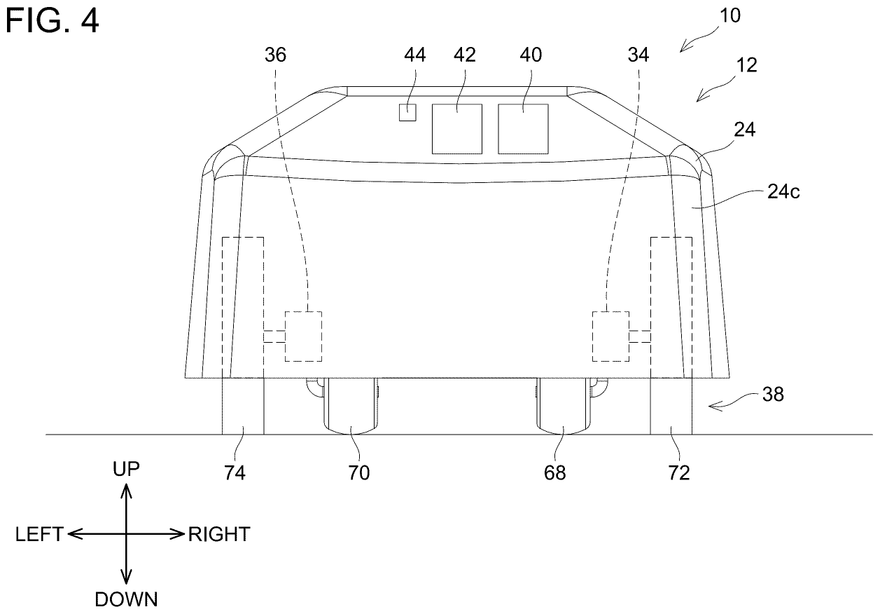

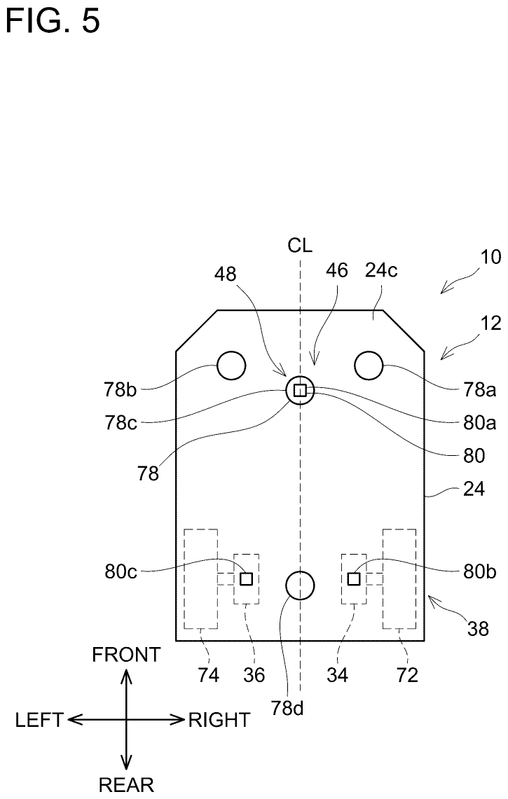

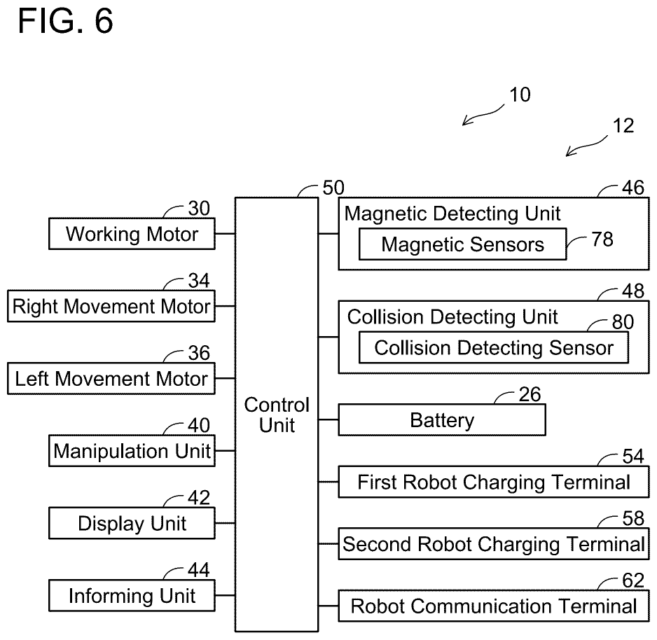

The longitudinal length of the working robot 12 is equal to or more than 500 mm and equal to or less than 1000 mm. As shown in FIG. 2, the working robot 12 comprises a housing 24, a battery 26, a terminal unit 28, a working motor 30, a working unit 32, a right movement motor 34 (see FIG. 4), a left movement motor 36 (see FIG. 4), a movement unit 38, a manipulation unit 40 (see FIG. 4), a display unit 42 (see FIG. 4), an informing unit 44 (see FIG. 4), a magnetic detecting unit 46 (see FIG. 5), a collision detecting unit 48 (see FIG. 5), and a control unit 50 (see FIG. 6).

The battery 26 is housed in the housing 24. The battery 26 is a secondary battery comprising a lithium-ion battery. The battery 26 is undetachable from the housing 24.

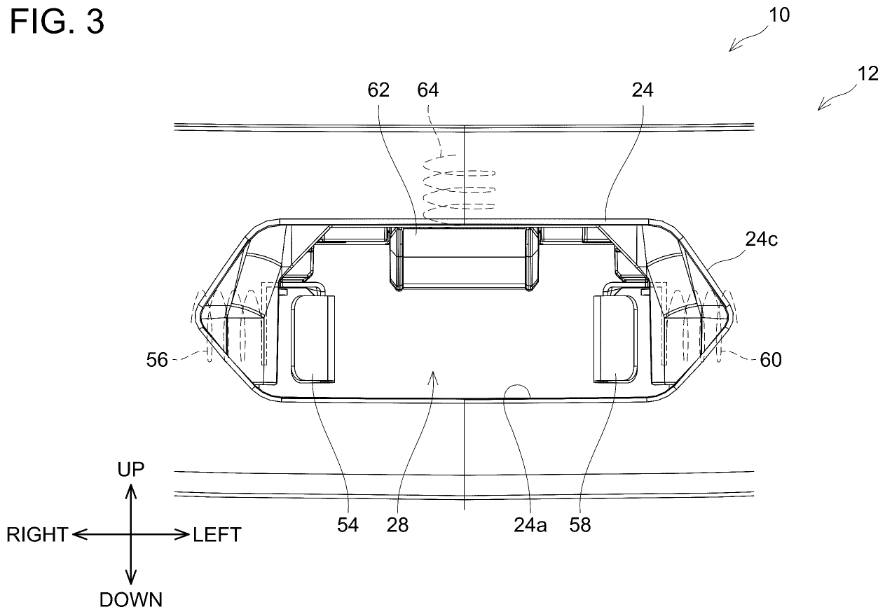

The terminal unit 28 is located near the front end of the housing 24. The housing 24 has a docking opening 24a. The docking opening 24a penetrates a front end portion of the housing 24 in the front-rear direction. The docking opening 24a is located at the center of the housing 24 in the right-left direction. As shown in FIG. 3, in the front view of the working robot 12, the terminal unit 28 is visible to a user through the docking opening 24a. The terminal unit 28 is located rearward of the docking opening 24a. The terminal unit 28 comprises a first robot charging terminal 54, a first biasing member 56, a second robot charging terminal 58, a second biasing member 60, a robot communication terminal 62, and a third biasing member 64.

The first robot charging terminal 54 corresponds to a robot power receiver. The first robot charging terminal 54 is electrically connected to the battery 26 (see FIG. 2). The first robot charging terminal 54 is supported by the housing 24 so as to be movable in the right-left direction. The first robot charging terminal 54 is biased leftward by the first biasing member 56. The first biasing member 56 is for example a compression spring.

The second robot charging terminal 58 corresponds to a robot power receiver. The second robot charging terminal 58 is electrically connected to the battery 26 (see FIG. 2). The second robot charging terminal 58 faces the first robot charging terminal 54 in the right-left direction. The second robot charging terminal 58 is supported by the housing 24 so as to be movable in the right-left direction. The second robot charging terminal 58 is biased rightward by the second biasing member 60. The first robot charging terminal 54 is biased toward the second robot charging terminal 58 by the first biasing member 56, and the second robot charging terminal 58 is biased toward the first robot charging terminal 54 by the second biasing member 60. The second biasing member 60 is for example a compression spring.

The robot communication terminal 62 is electrically connected to the control unit 50 (see FIG. 6). The robot communication terminal 62 is located above each of the first robot charging terminal 54 and the second robot charging terminal 58. In the right-left direction, the robot communication terminal 62 is located at the middle between the first robot charging terminal 54 and the second robot charging terminal 58. The robot communication terminal 62 is supported by the housing 24 so as to be movable in the up-down direction. The robot communication terminal 62 is biased downward by the third biasing member 64. The third biasing member 64 is for example a compression spring.

The working robot 12 is configured to dock with the charging station 14 (see FIG. 1) via the terminal unit 28. When the working robot 12 is docked with the charging station 14, the first robot charging terminal 54 or the second robot charging terminal 58 receives power from an external power supply 100 via the charging station 14. The power received by the first robot charging terminal 54 or the second robot charging terminal 58 is supplied to the battery 26. The battery 26 is thus charged.

As shown in FIG. 2, the working motor 30 is supported by the housing 24. The working motor 30 is for example a brushless motor. The working motor 30 operates using the power in the battery 26.

The working unit 32 comprises a substantially disk-shaped blade 32a. The blade 32a is fixed to the output shaft of the working motor 30. The output shaft is inclined to the up-down direction. The blade 32a is rotated by the operation of the working motor 30. The lawn on the ground is thereby mowed.

As shown in FIG. 4, the right movement motor 34 and the left movement motor 36 are supported by the housing 24. The right movement motor 34 and the left movement motor 36 are for example brushless motors. The right movement motor 34 and the left movement motor 36 operate using the power in the battery 26 (see FIG. 2).

The movement unit 38 comprises a right front auxiliary wheel 68, a left front auxiliary wheel 70, a right rear drive wheel 72, and a left rear drive wheel 74. The right front auxiliary wheel 68 and the left front auxiliary wheel 70 are attached to the housing 24. The right front auxiliary wheel 68 and the left front auxiliary wheel 70 each can rotate about a rotation axis extending in the right-left direction and also turn about a turning axis extending in the up-down direction. The right rear drive wheel 72 is fixed to the output shaft of the right movement motor 34. The left rear drive wheel 74 is fixed to the output shaft of the left movement motor 36. The output shaft of the right movement motor 34 and the output shaft of the left movement motor 36 extend in the right-left direction. The right rear drive wheel 72 is rotated by the operation of the right movement motor 34 operates, while the left rear drive wheel 74 is rotated by the operation of the left movement motor 36. Thus, the working robot 12 moves forward, moves rearward, and turns.

The manipulation unit 40 is located on the outer surface of the housing 24. The manipulation unit 40 comprises one or more manipulation switches. The user manipulates the manipulation unit 40 for example to switch the working robot 12 between on state and off state, to set a working condition of the working robot 12, etc.

The display unit 42 is for example a display. The display unit 42 displays various information. The manipulation unit 40 and the display unit 42 may be integrated as a touch screen.

The informing unit 44 is for example a buzzer configured to emit a sound. In a variant, the informing unit 44 may be a light configured to emit light. The informing unit 44 emits a sound for example when an abnormality occurs in the working robot 12.

As shown in FIG. 5, the magnetic detecting unit 46 is supported by the housing 24. The magnetic detecting unit 46 comprises a plurality of magnetic sensors 78 (four magnetic sensors 78 in this embodiment). The magnetic sensors 78 are for example search coils, Hall sensors, or the like. The magnetic sensors 78 each detect a magnetic field intensity in the up-down direction.

The plurality of magnetic sensors 78 comprises a right front magnetic sensor 78a, a left front magnetic sensor 78b, a center front magnetic sensor 78c, and a rear magnetic sensor 78d. The right front magnetic sensor 78a, the left front magnetic sensor 78b, and the center front magnetic sensor 78c are located forward of the center of the housing 24 in the front-rear direction. The right front magnetic sensor 78a is located on/in a right front portion of the housing 24. The left front magnetic sensor 78b is located on/in a left front portion of the housing 24. In the right-left direction, a distance from the right front magnetic sensor 78a to a center line CL is substantially equal to a distance from the left front magnetic sensor 78b to the center line CL. The center line CL extends in the font-rear direction and is located at the center of the housing 24 in the right-left direction. The center front magnetic sensor 78c and the rear magnetic sensor 78d are located near the center line CL. The center front magnetic sensor 78c is located on/in a front portion of the housing 24. The rear magnetic sensor 78d is located rearward of the center of the housing 24 in the front-rear direction. The rear magnetic sensor 78d is located on/in a rear portion of the housing 24.

The housing 24 comprises a base 24b (see FIG. 2) and a bumper 24c movably attached to the base 24b, and the collision detecting unit 48 is supported by the base 24b and the bumper 24c. Usually, the bumper 24c is in an initial position relative to the base 24b. The docking opening 24a (see FIG. 2) is located at the front end of the bumper 24c. The collision detecting unit 48 comprises a plurality of collision detection sensors 80 (three collision detection sensors 80 in this embodiment). The collision detection sensors 80 each detect a collision of the housing 24 against an obstacle by detecting displacement of the bumper 24c from the initial position. When the displacement of the bumper 24c from the initial position is equal to or greater than a predetermined value (i.e., when the housing 24 is colliding with an obstacle, etc.), the collision detection sensors 80 shift to an on state (in which the collision detection sensors 80 are detecting the collision of the housing 24 against the obstacle), whereas when the displacement of the bumper 24c from the initial position is less than the predetermined value (i.e., when the housing 24 is not colliding with an obstacle, etc.), the collision detection sensors 80 shift to an off state (in which the collision detection sensors 80 are not detecting any collision of the housing 24 against an obstacle).

The collision detection sensors 80 comprise a center collision detection sensor 80a, a right collision detection sensor 80b, and a left collision detection sensor 80c. The center collision detection sensor 80a is located directly above the center front magnetic sensor 78c. The right collision detection sensor 80b is located directly above the right movement motor 34. The left collision detection sensor 80c is located directly above the left movement motor 36. A distance from the right collision detection sensor 80b to the center line CL is substantially equal to a distance from the left collision detection sensor 80c to the center line CL.

As shown in FIG. 6, the control unit 50 is electrically connected to the battery 26, the first robot charging terminal 54, the second robot charging terminal 58, the robot communication terminal 62, the working motor 30, the right movement motor 34, the left movement motor 36, the manipulation unit 40, the display unit 42, the informing unit 44, the magnetic detecting unit 46, and the collision detecting unit 48. The control unit 50 comprises a microcomputer (not shown) and a memory (not shown). The control unit 50 controls the rotation direction and rotation speed of the right movement motor 34 and the rotation direction and rotation speed of the left movement motor 36 independently. For example, when the control unit 50 controls the right movement motor 34 and the left movement motor 36 to run in the forward direction and at the same rotation speed, the working robot 12 moves forward. When the control unit 50 controls the right movement motor 34 and the left movement motor 36 to run in the reverse direction and at the same rotation speed, the working robot 12 moves rearward. When the control unit 50 controls the right movement motor 34 to run in the forward direction and controls the left movement motor 36 to run in the reverse direction, the working robot 12 turns on the spot. When the control unit 50 controls the right movement motor 34 and the left movement motor 36 to run in the forward direction (or in the reverse direction) at different rotation speeds, the working robot 12 moves forward (or rearward) while turning. The control unit 50 autonomously controls the working robot 12 according to various programs stored in the memory. For example, the control unit 50 acquires signals from the manipulation unit 40 and the magnetic detecting unit 46 and controls the working motor 30, the right movement motor 34, and the left movement motor 36 accordingly, so that the working robot 12 mows the lawn while autonomously moving.

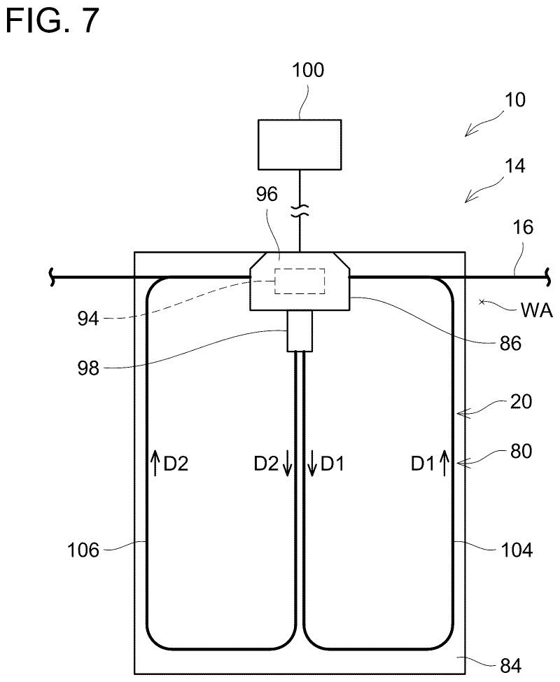

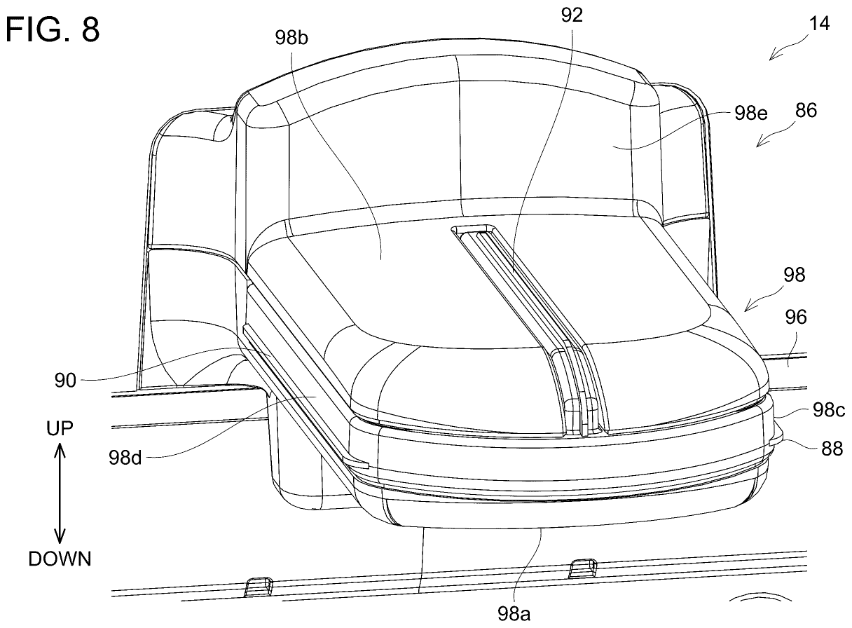

As shown in FIG. 7, the charging station 14 is partially within the working area WA and partially out of the working area WA. The charging station 14 comprises a station plate 84, a stand 86, a first station charging terminal 88 (see FIG. 8), a second station charging terminal 90 (see FIG. 8), a station communication terminal 92 (see FIG. 8), and a signal generator 94. The station plate 84 is placed on the ground. The station plate 84 is substantially rectangular in shape as viewed from above. The longitudinal length of the station plate 84 is for example equal to or more than 700 mm and equal to or less than 1200 mm. The longitudinal length of the station plate 84 is greater than the longitudinal length of the working robot 12 (see FIG. 5).

The stand 86 is disposed on the station plate 84. The stand 86 comprises a base 96 and a docking member 98. The base 96 extends upward from the station plate 84. The docking member 98 is configured to allow the working robot 12 to dock therewith (see FIG. 2). The docking member 98 projects from the base 96 in a direction away from the boundary wire 16. The projecting direction of the docking member 98 from the base 96 is substantially the same as the longitudinal direction of the station plate 84. The docking member 98 is substantially perpendicular to the base 96. The docking member 98 is substantially parallel to the ground. The docking member 98 is located within the working area WA. As shown in FIG. 8, the docking member 98 comprises a lower wall 98a facing the ground, an upper wall 98b opposite to the lower wall 98a, a first side wall 98c connecting the lower wall 98a to the upper wall 98b, a second side wall 98d opposite to the first side wall 98c, and a contact portion 98e projecting upward from the upper wall 98b.

The first station charging terminal 88, the second station charging terminal 90, and the station communication terminal 92 are electrically connected to the external power supply 100 (see FIG. 7). The first station charging terminal 88 and the second station charging terminal 90 each correspond to a station power transmitter. The first station charging terminal 88 is located in the first side wall 98c of the docking member 98. The first station charging terminal 88 is partially exposed from the first side wall 98c. The second station charging terminal 90 is located in the second side wall 98d of the docking member 98. The second station charging terminal 90 is partially exposed from the second side wall 98d. The station communication terminal 92 is located in the upper wall 98b of the docking member 98. The station communication terminal 92 is partially exposed from the upper wall 98b. The first station charging terminal 88, the second station charging terminal 90, and the station communication terminal 92 extend in the projecting direction of the docking member 98.

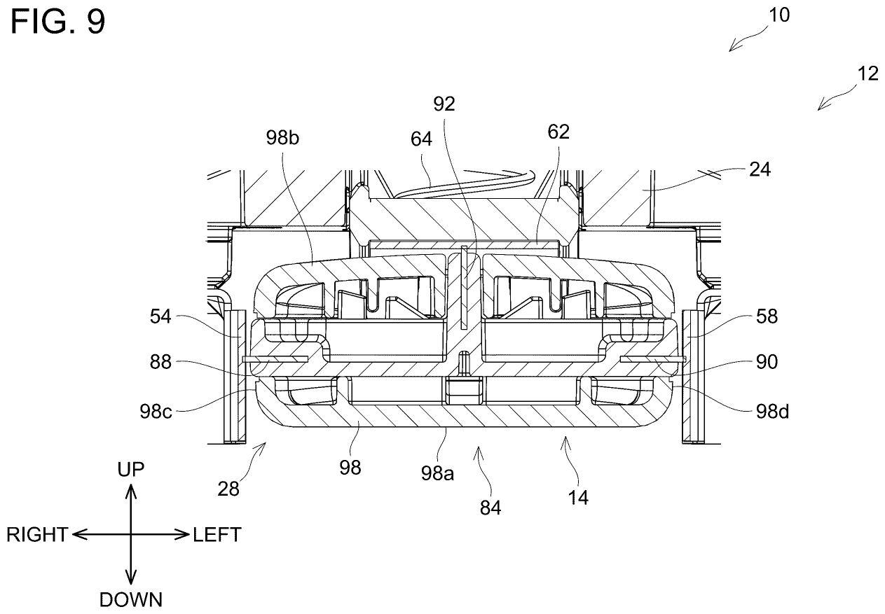

As shown in FIG. 9, when the charging station 14 has the working robot 12 docked therewith, the docking member 98 is inside the docking opening 24a (see FIG. 3), the upper wall 98b of the docking member 98 faces the robot communication terminal 62 in the up-down direction, the first side wall 98c of the docking member 98 faces the first robot charging terminal 54 in the right-left direction, the second side wall 98d of the docking member 98 faces the second robot charging terminal 58 in the right-left direction, and the contact portion 98e (see FIG. 8) of the stand 86 is in contact with the housing 24. In this state, the first station charging terminal 88 is in contact with the first robot charging terminal 54, the second station charging terminal 90 is in contact with the second robot charging terminal 58, and the station communication terminal 92 is in contact with the robot communication terminal 62. The contact between the first station charging terminal 88 and the first robot charging terminal 54 is maintained by the first robot charging terminal 54 being pressed against the first station charging terminal 88 by the biasing force of the first biasing member 56 (see FIG. 3). The contact between the second station charging terminal 90 and the second robot charging terminal 58 is maintained by the second robot charging terminal 58 being pressed against the second station charging terminal 90 by the biasing force of the second biasing member 60 (see FIG. 3). The contact between the station communication terminal 92 and the robot communication terminal 62 is maintained by the robot communication terminal 62 being pressed against the station communication terminal 92 by the biasing force of the third biasing member 64. Thus, the first station charging terminal 88 is electrically connected to the first robot charging terminal 54, the second station charging terminal 90 is electrically connected to the second robot charging terminal 58, and the station communication terminal 92 is electrically connected to the robot communication terminal 62. In this state, a current flows from the first station charging terminal 88 to the first robot charging terminal 54 or from the second station charging terminal 90 to the second robot charging terminal 58. Thus, power of the external power supply 100 (see FIG. 7) for charging the battery 26 (see FIG. 6) is supplied from the first station charging terminal 88 to the first robot charging terminal 54 or from the second station charging terminal 90 to the second robot charging terminal 58.

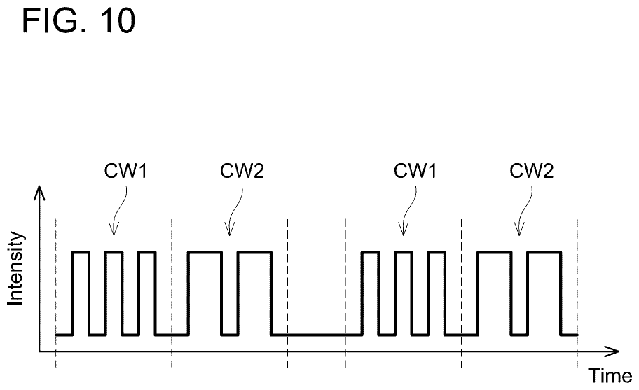

As shown in FIG. 7, the signal generator 94 is housed in the base 96. The signal generator 94 is configured to supply a first electric signal to the boundary wire 16 and the station wire 20. The signal generator 94 is further configured to supply a second electric signal to the boundary wire 16 and the guide wire 18. As shown in FIG. 10, a current waveform CW1 of the first electric signal is different from a current waveform CW2 of the second electric signal. For example, the pulse length and the number of pulses in the current waveform CW1 of the first electric signal are different from the pulse length and the number of pulses in the current waveform CW2 of the second electric signal. In a variant, the phase of the current waveform CW1 of the first electric signal may be different from the phase of the current waveform CW2 of the second electric signal. The first electric signal and the second electric signal are supplied by the signal generator 94 alternately, for example. The first electric signal and the second electric signal are supplied by the signal generator 94 at predetermined intervals, for example.

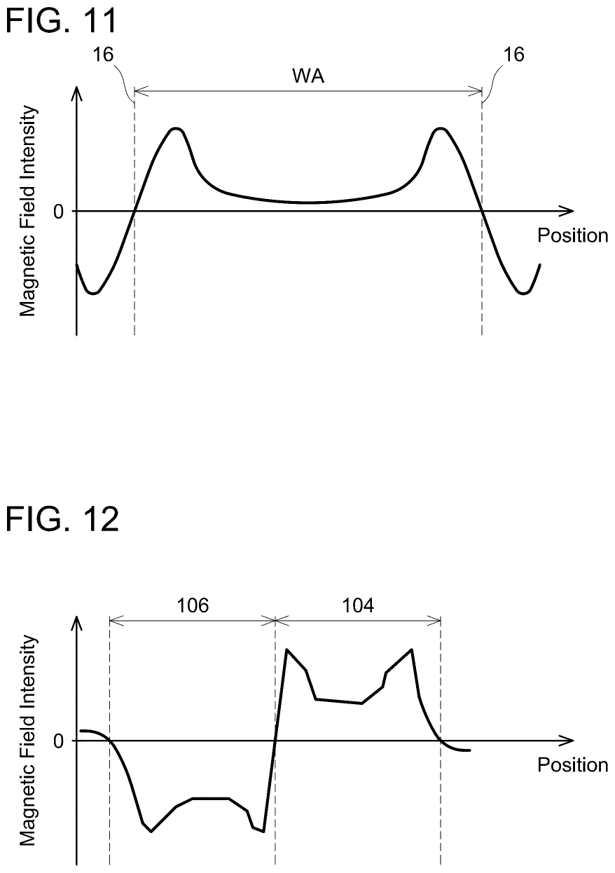

As shown in FIG. 1, the boundary wire 16 defines the working area WA. The boundary wire 16 is for example buried in the ground near the ground surface. The boundary wire 16 is electrically connected to the signal generator 94 (see FIG. 7) of the charging station 14 via the station wire 20. When a current flows in the boundary wire 16, a magnetic field that surrounds the boundary wire 16 is generated according to the Ampere's law. The direction of the magnetic field within the working area WA is different from the direction of the magnetic field outside the working area WA. As shown in FIG. 11, the intensity of the magnetic field in the up-down direction is zero on/immediately above the boundary wire 16, indicates a positive value within the working area WA, and indicates a negative value outside the working area WA. The intensity of the magnetic field depends on the distance from the boundary wire 16. The control unit 50 obtains the intensity of the magnetic field from the magnetic detecting unit 46 and determines whether the working robot 12 is within the working area WA.

As shown in FIG. 1, for example, the guide wire 18 is buried in the ground near the ground surface. The guide wire 18 is electrically connected to a first point 17 of the boundary wire 16. The first point 17 can be positioned anywhere between one end and the other end of the boundary wire 16. Hereinafter, a portion of the boundary wire 16 between the one end and the first point 17 may be termed a first boundary wire portion 16a, and another portion of the boundary wire 16 between the first point 17 and the other end may be termed a second boundary wire portion 16b. The guide wire 18 is also electrically connected to the signal generator 94 (see FIG. 7) of the charging station 14. The guide wire 18 and the first boundary wire portion 16a define a guide area GA. When a current flows in the guide wire 18 and the first boundary wire portion 16a, a magnetic field that surrounds the guide wire 18 and the first boundary wire portion 16a is generated according to the Ampere's law. In this embodiment, the first electric signal is supplied when a current flows through the first boundary wire portion 16a first and then the second boundary wire portion 16b, whereas the second electric signal is supplied when a current flows through the first boundary wire portion 16a first and then the guide wire 18. The control unit 50 obtains the intensity of the magnetic field from the magnetic detecting unit 46 and determines whether the working robot 12 is within the guide area GA.

As shown in FIG. 7, the station wire 20 is disposed on the station plate 84 of the charging station 14. The station wire 20 is electrically connected in series to the boundary wire 16. The station wire 20 is electrically connected to the signal generator 94 (see FIG. 7).

The station wire 20 comprises a first loop portion 104 and a second loop portion 106 each having a looped shape. The first loop portion 104 and the second loop portion 106 are adjacent to each other. The docking member 98 of the charging station 14 is located on the boundary between the first loop portion 104 and the second loop portion 106. The first loop portion 104 and the second loop portion 106 are formed by winding the single station wire 20 more than once (e.g., twice). In the station wire 20, a current flows in the first loop portion 104 in a counterclockwise direction D1 and flows in the second loop portion 106 in a clockwise direction D2. As shown in FIG. 12, the intensity of the magnetic field in the up-down direction is zero in the vicinity of the boundary between the first loop portion 104 and the second loop portion 106, indicates a positive value within the first loop portion 104, and indicates a negative value within the second loop portion 106. The control unit 50 obtains one or more intensities of the magnetic field from the magnetic detecting unit 46 to determine whether the working robot 12 is within the first loop portion 104 or within the second loop portion 106 and detect that the working robot 12 has crossed over the station wire 20.

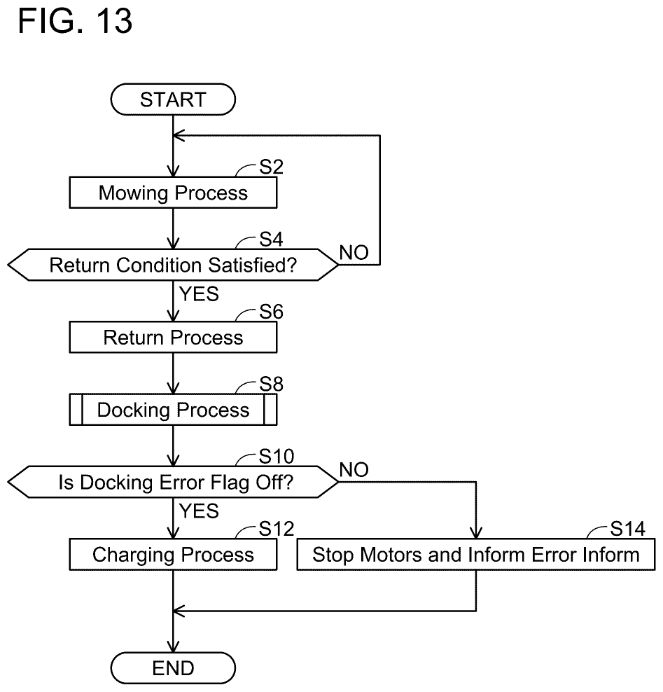

(Autonomous Control Process) The control unit 50 executes an autonomous control process shown in FIG. 13. The autonomous control process is executed to cause the working robot 12 to perform a mowing operation within the working area WA, to return the working robot 12 to the charging station 14, to dock the working robot 12 with the charging station 14, and to charge the working robot 12.

In S2 shown in FIG. 13, the control unit 50 executes a mowing process. Specifically, the control unit 50 drives the working motor 30, the right movement motor 34, and the left movement motor 36. This causes the working robot 12 to move within the working area WA while rotating the blade 32a, so that the lawn within the working area WA is mowed.

In S4, the control unit 50 determines whether a return condition is satisfied. The control unit 50 determines that the return condition is satisfied for example when the remaining amount of power in the battery 26 reaches a predetermined amount or less. Alternatively, the control unit 50 may determine that the return condition is satisfied when the current time is past a time set by the user or when an abnormality occurs in at least one of the working motor 30, the right movement motor 34, and the left movement motor 36. When the control unit 50 determines that the return condition is satisfied (YES in S4), the process proceeds to S6, whereas when the control unit 50 determines that the return condition is not satisfied (NO in S4), the process returns to S2.

In S6, the control unit 50 executes a return process. Specifically, the control unit 50 drives the right movement motor 34 and the left movement motor 36 based on one or more magnetic field intensities detected by the magnetic sensors 78 such that the working robot 12 can reach the charging station 14. At this time, the working robot 12 moves in a return direction D3 along the guide wire 18 and the first boundary wire portion 16a or moves in a return direction D4 along the first boundary wire portion 16a and the second boundary wire portion 16b. As shown in FIG. 1, the return directions D3, D4 are each the counterclockwise direction as the working robot 12 is viewed from the above. The control unit 50 keeps driving the working motor 30 until the working robot 12 reaches the charging station 14. That is, the working robot 12 moves while rotating the blade 32a. Thus, the lawn within the working area WA is mowed during the return process as well.

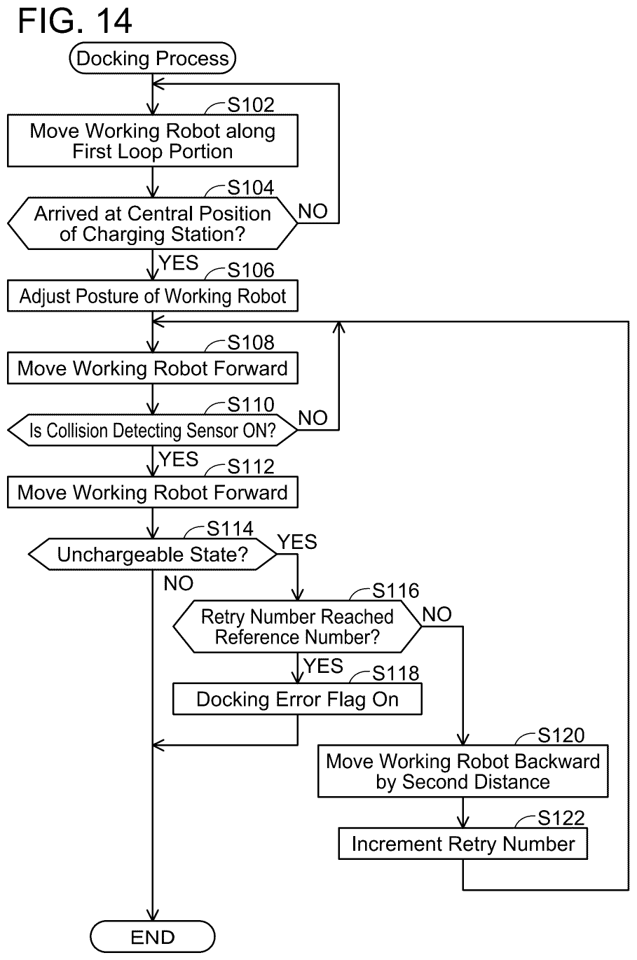

In S8, the control unit 50 executes a docking process shown in FIG. 14. In S102 of the docking process shown in FIG. 14, the control unit 50 drives the right movement motor 34 and the left movement motor 36 based on one or more magnetic field intensities of the first loop portion 104 detected by the magnetic sensors 78 such that the working robot 12 can move along the first loop portion 104. The working robot 12 moves clockwise along the first loop portion 104.

In S104, the control unit 50 determines whether the working robot 12 has reached a center position of the charging station 14 based on one or more magnetic field intensities of the first loop portion 104 detected by the magnetic sensors 78. The center position of the charging station 14 is the position at which the magnetic field intensity of the station wire 20 is zero, i.e., the boundary between the first loop portion 104 and the second loop portion 106. When the control unit 50 determines that the working robot 12 has reached the center position of the charging station 14 (YES in S104), the process proceeds to S106, whereas when the control unit 50 determines that the working robot 12 has not reached the center position of the charging station 14 (NO in S104), the process returns to S102.

In S106, the control unit 50 drives the right movement motor 34 and the left movement motor 36 to adjust the orientation of the working robot 12. Consequently, the docking opening 24a is located directly above the boundary between the first loop portion 104 and the second loop portion 106 so as to face the docking member 98 of the charging station 14.

In S108, the control unit 50 drives the right movement motor 34 and the left movement motor 36 to run in the forward direction and at the same speed such that the working robot 12 moves forward along the boundary between the first loop portion 104 and the second loop portion 106. The working robot 12 thus approaches the docking member 98.

In S110, the control unit 50 determines whether at least one of the collision detection sensors 80 is in the on state. At least one of the collision detection sensors 80 being in the on state in S110 means that the docking member 98 is in contact with the front end of the housing 24 (the bumper 24c) and faces the docking opening 24a. When the control unit 50 determines that at least one of the collision detection sensors 80 is in the on state (YES in S110), the process proceeds to S112, whereas the control unit 50 determines that all the collision detection sensors 80 are in the off state (NO in S110), the process returns to S108.

In S112, the control unit 50 controls the right movement motor 34 and the left movement motor 36 to rotate by a predetermined number of rotations in the forward direction and at the same speed such that the working robot 12 can move forward. When the right movement motor 34 and the left movement motor 36 rotate by the predetermined number of rotations in the forward direction and at the same speed without the working robot 12 colliding with any obstacle, the working robot 12 moves a first distance forward. The first distance is for example equal to or more than 50 mm and equal to or less than 650 mm. For example, the first distance may be equal to or more than 150 mm and equal to or less than 300 mm. For example, the first distance is 200 mm. The first distance is greater than the length of the docking member 98 in the projecting direction. When the right movement motor 34 and the left movement motor 36 are rotated by the predetermined number of rotations in the forward direction and at the same speed, the docking member 98 is inserted into the docking opening 24a and the front end of the housing 24 is pressed against the contact portion 98e of the docking member 98.

In S114 shown in FIG. 14, the control unit 50 determines whether the working robot 12 is in an unchargeable state in which charging to the battery 26 is unable to be started at the charging station 14. For example, the working robot 12 is in the unchargeable state when foreign matters, such as pieces of lawn cut by the blade 32a, are stuck between the first station charging terminal 88 and the first robot charging terminal 54, and/or between the second station charging terminal 90 and the second robot charging terminal 58, and/or between the station communication terminal 92 and the robot communication terminal 62. The control unit 50 determines that the working robot 12 is in the unchargeable state when the working robot 12 is not communicable with the charging station 14 (when the second station charging terminal 90 is not electrically connected to the second robot charging terminal 58 and/or the station communication terminal 92 is not electrically connected to the robot communication terminal 62). In a variant, the control unit 50 may determine that the working robot 12 is in the unchargeable state when the first station charging terminal 88 is not electrically connected to the first robot charging terminal 54 and/or the second station charging terminal 90 is not electrically connected to the second robot charging terminal 58. When the control unit 50 determines that the working robot 12 is not in the unchargeable state (NO in S114), the process proceeds to S10 in FIG. 13, whereas when the control unit 50 determines that the working robot 12 is in the unchargeable state (YES in S114), the process proceeds to S116. A sequence executed after YES in S114 (i.e., S116 to S122, and S108 to S114) corresponds to a docking retry process.

In S116, the control unit 50 determines whether the number of retries is equal to a reference number. The number of retries indicates how many times the docking retry process has been executed. Thus, the number of retries is zero when the docking retry process is executed for the first time. The control unit 50 resets the number of retries to zero every time the working robot 12 is charged at the charging station 14. The reference number is an integer equal to or larger than 1. For example, the reference number is 1. When the control unit 50 determines that the number of retries is equal to the reference number (YES in S116), the process proceeds to S118, whereas when the control unit 50 determines that the number of retries is less than the reference number (NO in S116), the process proceeds to S120.

In S118, the control unit 50 switches a docking error flag from off to on. The docking error flag is stored in the memory of the control unit 50. Then, the process proceeds to S10 in FIG. 13.

In S120, the control unit 50 drives the right movement motor 34 and the left movement motor 36 to rotate by a predetermined number of rotations in the reverse direction and at the same speed such that the working robot 12 can move rearward. Consequently, the working robot 12 moves a second distance rearward along the boundary between the first loop portion 104 and the second loop portion 106 to separate from the docking member 98. The second distance is for example equal to or more than 50 mm and equal to or less than 650 mm. For example, the second distance may be equal to or more than 150 mm and equal to or less than 300 mm. For example, the second distance is 200 mm. The second distance is greater than the length of the docking member 98 in the projecting direction. For example, the second distance is substantially equal to the first distance. The retreating process to move the working robot 12 rearward in S120 corresponds to a separation process to separate the working robot 12 from the docking member 98. When the working robot 12 moves the second distance rearward, the first robot charging terminal 54 separates from the first station charging terminal 88, the second robot charging terminal 58 separates from the second station charging terminal 90, and the robot communication terminal 62 separates from the station communication terminal 92. Thereby, the foreign matters, such as pieces of lawn cut by the blade 32a, fall off from the first robot charging terminal 54 and/or the second robot charging terminal 58 and/or the robot communication terminal 62 and/or the first station charging terminal 88 and/or the second station charging terminal 90 and/or the station communication terminal 92. Further, the docking member 98 comes out from the docking opening 24a. Thus, the working robot 12 undocks from the charging station 14.

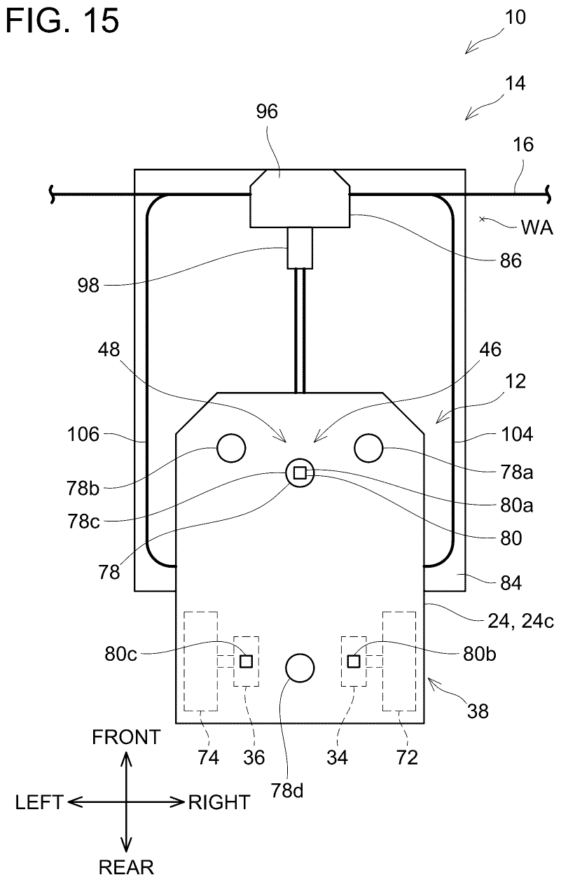

As shown in FIG. 15, after the working robot 12 has moved the second distance rearward, a part of the working robot 12 corresponding to 50% or more of the longitudinal length of the working robot 12 overlaps the station plate 84 as the working robot 12 is viewed in the down direction perpendicular to the ground. That is, while the working robot 12 is moving rearward, the part of the working robot 12 corresponding to 50% or more of the longitudinal length keeps overlapping the station plate 84 as the working robot 12 is viewed in the down direction. The working robot 12 has a first area as the working robot 12 is viewed in the down direction. After the working robot 12 has moved the second distance rearward, a part of the working robot 12 corresponding to 50% or more of the first area overlaps the station plate 84 as the working robot 12 is viewed in the down direction perpendicular to the ground. That is, while the working robot 12 is moving rearward, the part of the working robot 12 corresponding to 50% or more of the first area keeps overlapping the station plate 84 as the working robot 12 is viewed in the down direction.

In S122 shown in FIG. 14, the control unit 50 increments the number of retries by 1. After this, the process returns to S108.

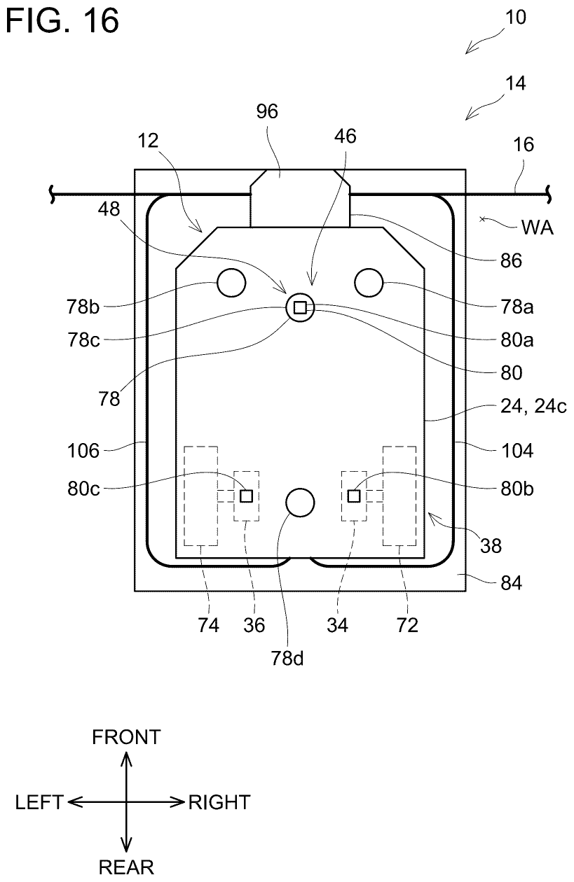

In the following sequence from S108 to S114, the working robot 12 moves forward again along the boundary between the first loop portion 104 and the second loop portion 106. Consequently, the docking member 98 is inserted into the docking opening 24a and the front end of the housing 24 is pressed against the contact portion 98e of the docking member 98. Thus, the working robot 12 docks with the charging station 14. The advancing process to move the working robot 12 forward in S108 to S114 corresponds to an approaching process to move the working robot 12 closer to the docking member 98. As shown in FIG. 16, after the working robot 12 has moved forward, the entire working robot 12 overlaps the station plate 84 as the working robot 12 is viewed in the down direction. That is, while the working robot 12 is moving forward, the part of the working robot 12 corresponding to 50% or more of the longitudinal length of the working robot 12 keeps overlapping the station plate 84 as the working robot 12 is viewed in the down direction. Further, while the working robot 12 is moving forward, the part of the working robot 12 corresponding to 50% or more of the first area keeps overlapping the station plate 84 as the working robot 12 is viewed in the down direction.

S10 shown in FIG. 13 is executed after NO in S114 and also after S118 shown in FIG. 14. In S10, the control unit 50 determines whether the docking error flag is off. When the control unit 50 determines that the docking error flag is off (YES in S10), the process proceeds to S12, whereas when the control unit 50 determines that the docking error flag is not off, i.e., that the docking error flag is on (NO in S10), the process proceeds to S14.

In S12, the control unit 50 executes a charging process. The battery 26 is thereby charged. After this, the control unit 50 terminates the autonomous control process.

In S14, the control unit 50 stops the right movement motor 34 and the left movement motor 36. Thus, the working robot 12 is stopped. Further, the control unit 50 controls the informing unit 44. The sound from the informing unit 44 informs the user of occurrence of an abnormality in the working robot 12. After this, the control unit 50 terminates the autonomous control process.

(Effects) The autonomous movement system 10 according to this embodiment comprises the working robot 12 configured to perform an operation while moving autonomously in the working area WA; and the charging station 14 configured to charge the working robot 12 and allow the working robot 12 to dock therewith. The working robot 12 comprises the working unit 32 configured to perform the operation; the movement unit 38 configured to move the working robot 12; the right movement motor 34 and the left movement motor 36 (examples of movement motor) configured to drive the movement unit 38; the battery 26 configured to be charged at the charging station 14 and supply power to the right movement motor 34 and the left movement motor 36; the control unit 50 configured to control the right movement motor 34 and the left movement motor 36; and the first robot charging terminal 54 (an example of robot power receiver) configured to receive power for charging the battery 26 from the charging station 14 while the working robot 12 is docked with the charging station 14. The charging station 14 comprises the first station charging terminal 88 (an example of station power transmitter) configured to supply the power for charging the battery 26 to the first robot charging terminal 54; and the station plate 84 placed on the ground. When the working robot 12 is docked with the charging station 14 and in the unchargeable state in which charging to the battery 26 is unable to be started, the control unit 50 executes the docking retry process to move the working robot 12 by the movement unit 38 and dock the working robot 12 again with the charging station 14. While the working robot 12 is moving during the docking retry process, at least a part of the working robot 12 overlaps the station plate 84 as viewed in the direction perpendicular to the ground.

According to the configuration above, while the working robot 12 is moving during the docking retry process, at least a part of the working robot 12 remains overlapping the station plate 84. Thus, the distance for which the working robot 12 moves is shorter as compared to a distance for which the working robot 12 would move when it completely moves away from the station plate 84. Therefore, the docking retry process can be executed efficiently.

The first robot charging terminal 54 is electrically connected to the charging station 14 when the working robot 12 is docked with the charging station 14. The first station charging terminal 88 is electrically connected to the first robot charging terminal 54. The docking retry process comprises the separation process to separate the working robot 12 from the charging station 14. The first robot charging terminal 54 is separated away from the first station charging terminal 88 after the separation process.

The first robot charging terminal 54 may fail to electrically connect to the first station charging terminal 88 due to interposition of a foreign matter between the first robot charging terminal 54 and first the station charging terminal 88. Since the first robot charging terminal 54 is separated from the first station charging terminal 88 in the configuration above, such a foreign matter falls off from the interface between the first robot charging terminal 54 and the first station charging terminal 88. Thus, the first robot charging terminal 54 can be electrically connected to the first station charging terminal 88.

The control unit 50 drives the right movement motor 34 and the left movement motor 36 at a predetermined number of rotations in the docking retry process.

Control by the control unit 50 may be made complicated if the number of rotations of the right movement motor 34 and the left movement motor 36 is varied every time the docking retry process is executed. The configuration above suppresses the complexity in control by the control unit 50.

During the docking retry process, a part of the working robot 12 that corresponds to 50% or more of the longitudinal length of the working robot 12 overlaps the station plate 84 as the working robot 12 is viewed in the direction perpendicular to the ground.

The configuration above allows for a reduction in a moving distance of the working robot 12 during the docking retry process.

As viewed in the direction perpendicular to the ground, the working robot 12 has the first area. During the docking retry process, a part of the working robot 12 that corresponds to 50% or more of the first area overlaps the station plate 84 as the working robot 12 is viewed in the direction perpendicular to the ground.

The configuration above allows for a reduction in a moving distance of the working robot 12 during the docking retry process.

The docking retry process comprises the retreating process to move the working robot 12 rearward; and the advancing process to move the working robot 12 forward after the retreating process.

The configuration above facilitates docking the working robot 12 to the charging station 14 as compared to a configuration in which the working robot 12 turns to dock with the charging station 14.

A retreating distance by which the working robot 12 moves rearward in the retreating process is equal to or more than 50 mm and equal to or less than 650 mm.

The configuration above allows the working robot 12 to undock from the charging station 14 while suppressing the working robot 12 from moving away from the station plate 84.

The retreating distance is equal to or more than 150 mm and equal to or less than 300 mm.

The configuration above allows the working robot 12 to undock from the charging station 14 while suppressing the working robot 12 from moving away from the station plate 84.

The autonomous movement system 10 further comprises the informing unit 44 configured to inform the user. The control unit 50 is configured to execute the docking retry process once or more; and control the informing unit 44 when the number of the docking retry processes executed reaches the reference number.

When the number of docking retry processes executed reaches the reference number, an abnormality, such as an abnormality between the first robot charging terminal 54 and the first station charging terminal 88, often occurs. The configuration above can inform the user of such an abnormality through the informing unit 44.

The control unit 50 is configured to stop the right movement motor 34 and the left movement motor 36 when the number of the docking retry processes executed reaches the reference number.

The configuration above allows the working robot 12 to be stopped until the user approaches the working robot 12.

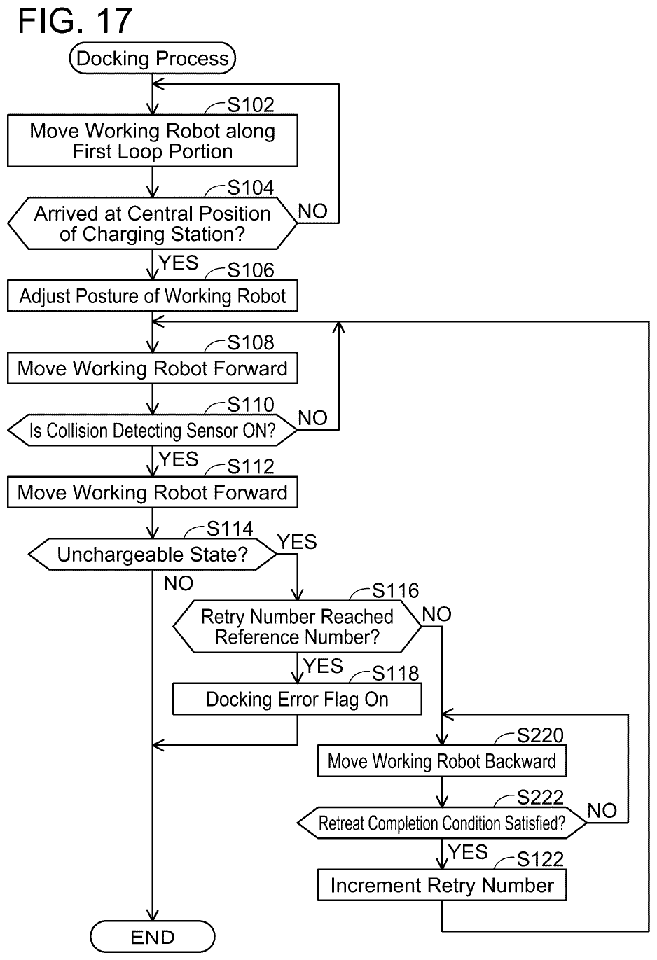

(Second Embodiment) For a second embodiment, differences from the first embodiment are described. As shown in FIG. 17, in a docking process according to the second embodiment, the control unit 50 executes S220 and S222 instead of S120 in the docking process according to the first embodiment.

In S220, the control unit 50 drives the right movement motor 34 and the left movement motor 36 in the reverse direction and at the same speed such that the working robot 12 can move rearward. Accordingly, the working robot 12 moves rearward along the boundary between the first loop portion 104 and the second loop portion 106 to separate from the docking member 98. When the working robot 12 moves rearward, the first robot charging terminal 54 separates from the first station charging terminal 88, the second robot charging terminal 58 separates from the second station charging terminal 90, and the robot communication terminal 62 separates from the station communication terminal 92.

In S222, the control unit 50 determines whether a retreating completion condition is satisfied. For example, the control unit 50 determines that the retreating completion condition is satisfied when a position detection sensor determines that the first robot charging terminal 54, the second robot charging terminal 58, and the robot communication terminal 62 have returned to their initial positions. In a variant, the working robot 12 comprises a switch that is configured to be pushed by the charging station 14 when the docking member 98 of the charging station 14 is in the docking opening 24a of the working robot 12, and the control unit 50 determines that the retreating completion condition is satisfied when the switch is not pushed. In another variant, the working robot 12 comprises a switch that is configured to be pushed by the charging station 14 when the first robot charging terminal 54 is not electrically connected to the first station charging terminal 88 and the second robot charging terminal 58 is not electrically connected to the second station charging terminal 90, and the control unit 50 determines that the retreating completion condition is satisfied when the switch is pushed. In yet another variant, the charging station 14 comprises a permanent magnet, the working robot 12 comprises a Hall sensor that is configured to face the permanent magnet when the docking member 98 of the charging station 14 is in the docking opening 24a of the working robot 12, and the control unit 50 determines that the retreating completion condition is satisfied when a magnetic field intensity detected by the Hall sensor is equal to or less than a predetermined value. In still another variant, the charging station 14 comprises a permanent magnet, the working robot 12 comprises a Hall sensor that is configured to face the permanent magnet when the first robot charging terminal 54 is not electrically connected to the first station charging terminal 88 and the second robot charging terminal 58 is not electrically connected to the second station charging terminal 90, and the control unit 50 determines that the retreating completion condition is satisfied when a magnetic field intensity detected by the Hall sensor is equal to or more than a predetermined value. When the control unit 50 determines that the retreating completion condition is satisfied (YES in S222), the process proceeds to S122, whereas when the control unit 50 determines that the retreating completion condition is not satisfied (NO in S222), the process returns to S220.

(Variants) In an embodiment, the working robot 12 may be a cleaner configured to remove foreign matters, such as dust, from a floor. The cleaner may remove foreign matters from a floor by rotating a brush and/or by suctioning the foreign matters.

In an embodiment, the battery 26 of the working robot 12 may be detachable from the housing 24.

In an embodiment, the movement unit 38 of the working robot 12 may comprise a crawler instead of the right front auxiliary wheel 68, the left front auxiliary wheel 70, the right rear drive wheel 72, and the left rear drive wheel 74.

In an embodiment, the docking process may include a turning process to turn the working robot 12.

In an embodiment, the charging station 14 may comprise a transmitter coil for wirelessly charging the working robot 12, instead of the first station charging terminal 88, the second station charging terminal 90, and the station communication terminal 92. The transmitter coil may be located in the base 96, in the docking member 98, or on the station plate 84. The working robot 12 may comprise a receiver coil for wireless charging via the transmitter coil. The receiver coil may be located in the housing 24 or in the terminal unit 28. If the transmitter coil of the charging station 14 is located on the station plate 84, the receiver coil may be located on the bottom surface of the housing 24 so as to face the transmitter coil on the station plate 84.

What is claimed is:

1. An autonomous movement system comprising:
a working robot configured to perform an operation while moving autonomously in a working area; and
a charging station configured to charge the working robot and allow the working robot to dock therewith,
wherein
the working robot comprises:
a working unit configured to perform the operation;
a movement unit configured to move the working robot;
a movement motor configured to drive the movement unit;
a battery configured to be charged at the charging station and supply power to the movement motor;
a control unit configured to control the movement motor; and
a robot power receiver configured to receive power for charging the battery from the charging station while the working robot is docked with the charging station,
the charging station comprises:
a station power transmitter configured to supply the power for charging the battery to the robot power receiver; and
a station plate placed on a ground,
when the working robot is docked with the charging station and in an unchargeable state in which charging to the battery is unable to be started, the control unit executes a docking retry process to move the working robot by the movement unit and dock the working robot again with the charging station, and
while the working robot is moving during the docking retry process, at least a part of the working robot overlaps the station plate as viewed in a direction perpendicular to the ground.

2. The autonomous movement system according to claim 1, wherein
the robot power receiver is a robot charging terminal configured to be electrically connected to the charging station when the working robot is docked with the charging station,
the station power transmitter is a station charging terminal configured to be electrically connected to the robot charging terminal,
the docking retry process comprises a separation process to separate the working robot from the charging station, and
the robot charging terminal is separated away from the station charging terminal after the separation process.

3. The autonomous movement system according to claim 1, wherein the control unit is configured to drive the movement motor at a predetermined number of rotations in the docking retry process.

4. The autonomous movement system according to claim 1, wherein during the docking retry process, a part of the working robot that corresponds to 50% or more of a length of the working robot in a robot longitudinal direction overlaps the station plate as the working robot is viewed in the direction perpendicular to the ground.

5. The autonomous movement system according to claim 1, wherein
as viewed in the direction perpendicular to the ground, the working robot has a first area, and
during the docking retry process, a part of the working robot that corresponds to 50% or more of the first area of the working robot overlaps the station plate as the working robot is viewed in the direction perpendicular to the ground.

6. The autonomous movement system according to claim 1, wherein
the docking retry process comprises:
a retreating process to move the working robot rearward; and
an advancing process to move the working robot forward after the retreating process.

7. The autonomous movement system according to claim 6, wherein a retreating distance by which the working robot moves rearward in the retreating process is equal to or more than 50 mm and equal to or less than 650 mm.

8. The autonomous movement system according to claim 7, wherein the retreating distance is equal to or more than 150 mm and equal to or less than 300 mm.

9. The autonomous movement system according to claim 1, further comprising an informing unit configured to inform a user,
wherein the control unit is configured to:
execute the docking retry process once or more; and
control the informing unit when a number of the docking retry process executed reaches a reference number.

10. The autonomous movement system according to claim 9, wherein the control unit is configured to stop the movement motor when the number of the docking retry process executed reaches the reference number.

11. The autonomous movement system according to claim 2, wherein
the control unit is configured to drive the movement motor at a predetermined number of rotations in the docking retry process,
during the docking retry process, a part of the working robot that corresponds 50% of more of a length of the working robot in a robot longitudinal direction overlaps the station plate as the working robot is viewed in the direction perpendicular to the ground,
as viewed in the direction perpendicular to the ground, the working robot has a first area,
during the docking retry process, a part of the working robot that corresponds to 50% or more of the first area of the working robot overlaps the station plate as the working robot is viewed in the direction perpendicular to the ground,
the docking retry process comprises:
a retreating process to move the working robot rearward; and
an advancing process to move the working robot forward after the retreating process,
a retreating distance by which the working robot moves rearward in the retreating process is equal to or more than 50 mm and equal to or less than 650 mm,
the retreating distance is equal to or more than 150 mm and equal to or less than 300 mm,
the autonomous movement system further comprises an informing unit configured to inform a user, and
the control unit is configured to:
execute the docking retry process once or more;
control the informing unit when a number of the docking retry process executed reaches a reference number; and
stop the movement motor when the number of the docking retry process executed reaches the reference number.
